(19) United States
(12) Patent Application Publication
(10) Pub. No.: US 2024/0085064 A1
(43) Pub. Date: Mar. 14, 2024

(54) GEOTHERMAL AERIFICATION SYSTEM AND RELATED METHODS

(71) Applicant: Capillary Concrete, LLC, Wellington, FL (US)

(72) Inventor: Martin STERNBERG, Wellington, FL (US)

(21) Appl. No.: 18/243,831

(22) Filed: Sep. 8, 2023

Related U.S. Application Data
(60) Provisional application No. 63/405,032, filed on Sep. 9, 2022.

(51) Int. Cl. F24T 50/00; A01G 25/06; A01G 31/02

(52) U.S. Cl. CPC F24T 50/00; A01G 25/06; A01G 31/02

(57) ABSTRACT

A geothermal aerification system includes a basin for storing water and a network of geothermal piping in fluid communication with the basin. The network of geothermal piping is configured to adjust a temperature of the water and is located at a depth below a ground surface to circulate the water to selectively absorb geothermal energy to increase a temperature of the water, or to dissipate heat to decrease the temperature of the water. The system also includes a network of water distribution pipes in fluid communication with the basin. The network of water distribution pipes is configured to discharge the water at the adjusted temperature proximate to the ground surface.

### CROSS-REFERENCE TO RELATED APPLICATIONS

This application claims the benefit of U.S. provisional application No. 63/405,032 filed Sep. 9, 2022, which is hereby incorporated herein in its entirety by reference.

### FIELD OF THE INVENTION

The present invention relates to aerification and hydroponics systems and more particularly to a geothermal aerification system for controlling temperature and moisture content below a surface portion of one or more areas to be irrigated.

### BACKGROUND

Systems and methods for efficient water management and optimal plant growth in agriculture and horticulture arrangements have been under constant development. Particularly, with recent increased awareness and efforts on minimizing the environmental impact of such systems even further advancements have been made. This includes minimizing the water consumption per irrigated area or even per plant while maximizing the efficiency of such systems. For instance, irrigation of the plants with careful monitoring and control over the moisture conditions of the growth environment in turn induces optimized plant growth as well as higher success rates in plant cultivation and economic returns.

There are several types of irrigation techniques such as furrow, flood, sprinkler, spray, sub-surface, drip, etc., with each having pros and cons. However, when it comes to maximizing irrigation efficiency, sub-surface systems have been mostly praised due to the fact that plant roots show a tendency in growing in line with the direction of a moisture gradient in the vicinity of the roots, thus when the moisture level is kept higher below the roots compared to the surface level, plants grow a deeper rooting network resulting in more stable and durable plants.

A variety of sub-surface systems have been introduced such as those shown in U.S. Pat. No. 5,590,980 and WO 85/00631, however, most of these arrangements are complicated and costly to install and do not completely provide a desirable controllable plant growth environment across a large area.

In one sub-surface irrigation system disclosed in EP 3355686 from the same applicant, a layered structure is used for sub-surface irrigation of planted surfaces. An embedded water control system controls the moisture level of a layer with rooting plants by controlling the moisture level of a porous layer which is installed underneath the rooting layer. By using this system, the plants experience a uniform irrigation over the whole irrigated area and water usage can be efficiently mitigated. However, optimally managing the amount of water excess or dearth to the needs of the plants as well as accurate control on the growth environment of the root zone can be a pressing challenge.

Therefore, there is a need to further develop systems for improving the desirable growth conditions for strong root networks and advancing the optimum plant growth environment while reducing the water usage and operation costs.

### SUMMARY

A geothermal aerification system is disclosed and is directed to hydroponically moving temperature controlled water infused with fertilizers and nutrients to a root zone of plants. The system includes a basin for storing water and a network of geothermal piping in fluid communication with the basin. The network of geothermal piping is configured to adjust a temperature of the water and is located at a depth below a ground surface to circulate the water to selectively absorb geothermal energy to increase a temperature of the water, or to dissipate heat to decrease the temperature of the water. The system also includes a network of water distribution pipes in fluid communication with the basin. The network of water distribution pipes is configured to discharge the water at the adjusted temperature at a root zone of plants.

Water absorption and management of plants is directly related to temperatures of the root zone. For example, summer root decline in bentgrass is one of the main problems for turf managers in the transition zone in the United States. The roots cannot survive the warm temperatures in the soil and start to die off. Thus, one advantage of the system is that it is configured to reduce the temperature of the irrigation water, which is distributed to the root zone to help the plants thrive.

In another aspect, the system may be used to heat areas such as equestrian sand arenas and other areas that do not have plants or grass. This also includes, but is not limited to, paths or roads and other outdoor areas. Accordingly, the heated (or cooled) water is discharged just below the surface using the water distribution pipes.

In yet another aspect, the basin has a first portion and a second portion. A first network of geothermal piping is in fluid communication with the first portion of the basin and a second network of geothermal piping is in fluid communication with the second portion of the basin. The first and second networks of geothermal piping are configured to adjust a temperature of water and are located at a depth below a ground surface to circulate the water to selectively absorb geothermal energy to increase a temperature of the water, or to dissipate heat to decrease the temperature of the water.

A first network of water distribution pipes is in fluid communication with the first portion of the basin, and a second network of water distribution pipes is in fluid communication with the second portion of the basin. The first and second networks of water distribution pipes are configured to discharge the water at the adjusted temperature at a root zone of plants.

The system may include pumping equipment to circulate the water through the first and second networks of geothermal piping and the first and second networks of water distribution pipes. The pumping equipment may comprise an air lift pump and the pumping equipment may be configured to raise and lower a height level of the water at a root zone of the plants within the respective sub-area. For example, the pumping equipment may be configured to alternatively raise and lower a height level of the water of the root zone of the respective sub-area by pumping the water to and from the first and second sub-areas. Thus, a gas exchange zone can be created in the root zone leading to optimal irrigation and oxygenation of the root zone by periodically raising and lowering the water level in the root zone of the sub-areas. In addition, the system may include one or more controllable valves configured to control a flow of the water.

In another aspect, a method of using the geothermal aerification system comprising a basin for storing water, a network of geothermal piping at a depth below a ground surface to selectively absorb or dissipate geothermal energy, and a network of water distribution pipes in fluid communication with the basin, is disclosed. The method includes circulating water from the basin to the network of geothermal piping to adjust a temperature of the water, and discharging the water through the network of water distribution pipes at the adjusted temperature and proximate to the ground surface.

### BRIEF DESCRIPTION OF THE DRAWINGS

The above objects, as well as additional objects, features and advantages of the present invention, will be more fully appreciated by reference to the following illustrative and non-limiting detailed description of embodiments of the present invention, when taken in conjunction with the accompanying drawings, wherein:

FIG. 1 is a schematic of a network of geothermal piping in which various aspects of the disclosure may be implemented;

FIG. 2 is a cross section of a portion of a geothermal aerification system of the present invention;

FIG. 3 is an exploded cross sectional view of the various layers of the aerification system shown in FIG. 2;

FIG. 4 is a plan view of a water distribution network in which various aspects of the disclosure may be implemented;

FIG. 5 is a top view of a basin of the geothermal aerification system shown in FIG. 2.

FIG. 6 is a partial cross sectional view of the basin of FIG. 5 taken in the direction of line 6-6; and

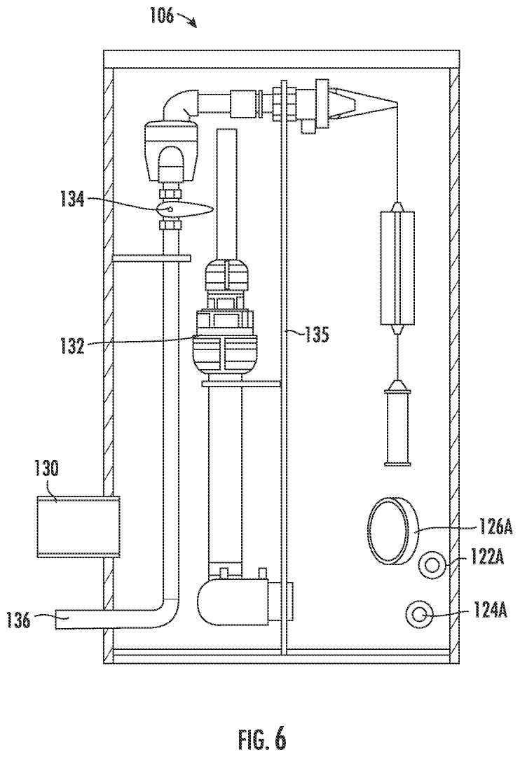

FIG. 7 is a partial cross sectional view of the basin of FIG. 5 taken in the direction of line 7-7.

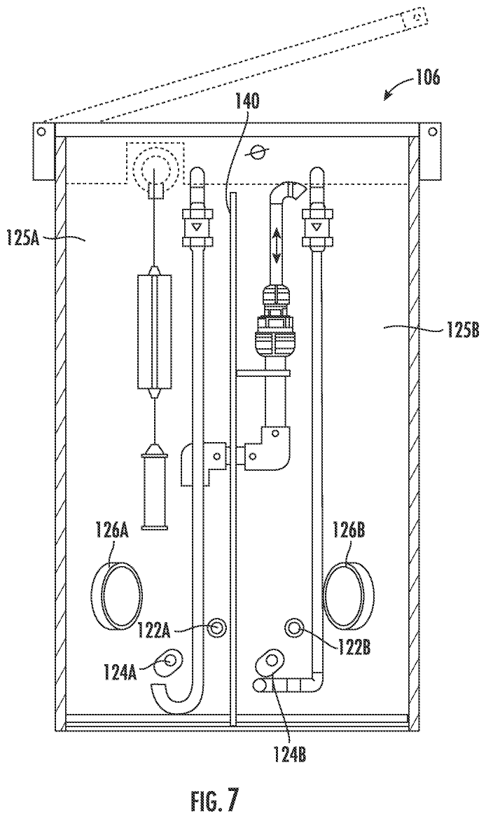

### DETAILED DESCRIPTION

In the present detailed description, embodiments of the present invention will be discussed with the accompanying figures. It should be noted that this by no means limits the scope of the invention, which is also applicable in other circumstances for instance with other types or variants of methods for providing aerification systems or other types or variants of the aerification systems than the embodiments shown in the appended drawings. Further, that specific features are mentioned in connection to an embodiment of the invention does not mean that those components cannot be used to an advantage together with other embodiments of the invention.

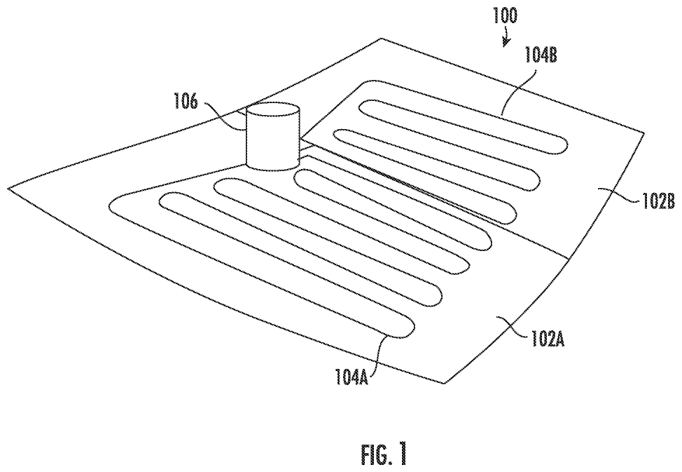

Referring now to FIG. 1, a network of geothermal piping for a geothermal aerification system 100 is shown. In a particular aspect, there may be a first sub-area 102A to be irrigated, and a second sub-area 102b. The sub-areas 102A, 102B may be large planted surfaces such as a lawn or a golf green or a tennis court, for example. Each of the sub-areas comprise similar components and are signified by the use of the designation “A” or “B”. FIG. 1 does not show the layers above the geothermal piping for clarity so that the first network of geothermal piping 104A and the second network of geothermal piping 104B are visible. The first and second network of geothermal piping 104A, 104B are in fluid communication with basin 106.

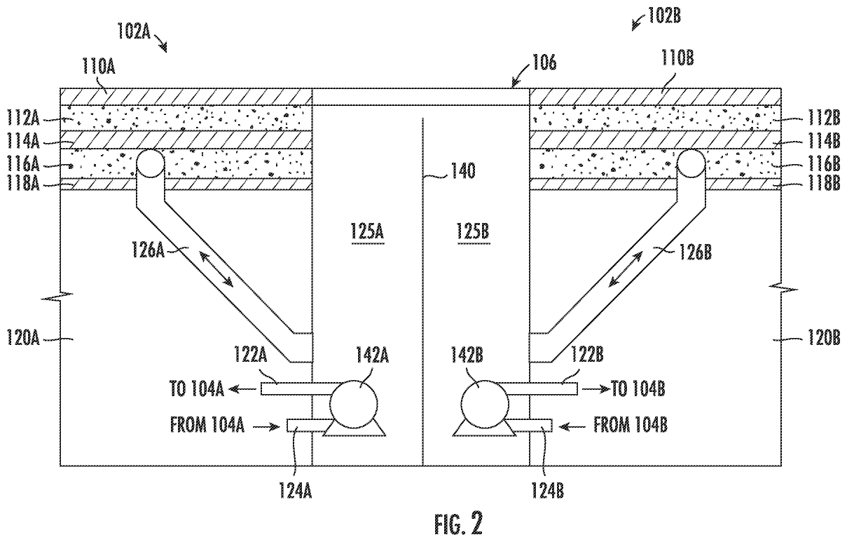

The aerification system 100 is installed in a compacted subgrade 120A, 120B as shown in FIG. 2. Each of the sub-areas 102A, 102B further comprises a substantially water impermeable layer 118A, 118B. The water impermeable layer 118A, 118B may comprise a plastic sheet, rubber sheet, or any equivalent material or membrane installed on the subgrade preventing water from draining any further downward. Each sub-area 102A, 102B further comprises a substantially water permeable layer 116A, 116B such as gravel that is placed on top of the water impermeable layer 118A, 118B. A porous concrete layer 114A, 114B may be positioned on top of the water permeable layer 116A, 116B and washed sand 112A, 112B or other rooting medium where roots of vegetation or plants 110A such as grass can be planted is the upper most layer.

The system 100 further comprises at least one conduit 126A, 126B in fluid communication with the water permeable layer 116A, 116B of the respective sub-systems 120A, 120B to the basin 106. The conduit 126A, 126B may be made of flexible or non-flexible materials.

The basin 106 also comprises couplings 122A, 122B, 124A, 124B that are connected to the networks of geothermal piping. The couplings may include valves that control the flow of water through the networks of geothermal piping. Geothermal pump 142A is coupled to the geothermal piping 104A and configured to circulate the water. Similarly, geothermal pump 142B is coupled to the geothermal piping 104B and configured to circulate the water.

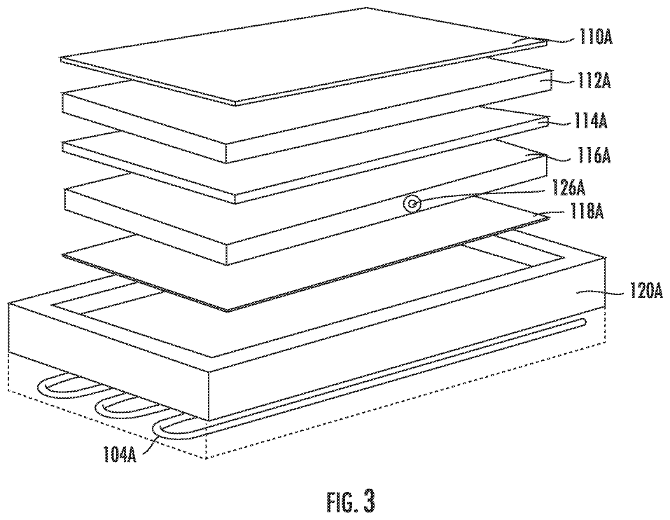

Referring now to FIG. 3, an exploded cross sectional view of the layers of one of the sub-areas 102A is shown. As described above, the top layer includes a plant layer 110A on top of rooting medium 112A. A layer of porous concrete 114A, for example Capillary Concrete manufactured by the Applicant, is below the rooting medium 112A. Below the porous concrete 114A is a permeable layer or gravel 116A, and which is where the water distribution pipes 126A are located. A water impermeable layer 118A is immediately below the gravel layer 116A. Below the impermeable layer 118A is where the network of geothermal piping is located. The geothermal piping must be deep enough within the ground where the temperature is relatively constant and not subject to freezing. For example, the geothermal piping 104A may be four feet below ground surface, or deeper.

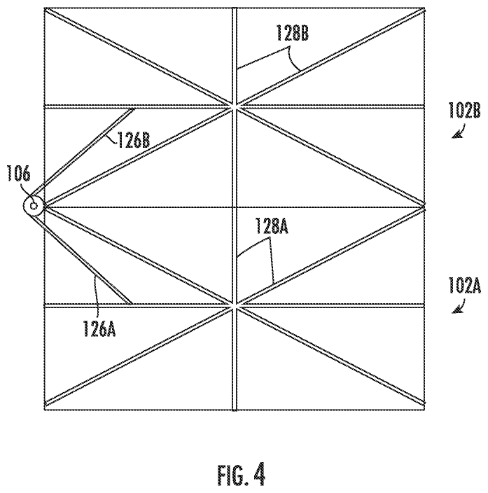

A water distribution network is shown in FIG. 4. In particular, the conduits 126A, 126B are in fluid communication with the basin 106. In addition, the conduits 126A, 126B are in communication with additional piping 128A, 128B that is used to distribute water to the rooting zone via capillary action over a larger area. The water distribution piping 128A, 128B may comprise perforated pipes and be 4 inches in diameter in a particular aspect. As explained above, the temperature of the water being distributed to the root zone has been adjusted using geothermal energy.

The system 100 may also be used to heat surface areas such as equestrian sand arenas and other areas that do not have plants or grass. This also includes, but is not limited to, inorganic materials such as hardscaped areas, paths, roads and other outdoor areas. Accordingly, the heated (or cooled) water is discharged just below the surface using the water distribution pipes 128A, 128B.

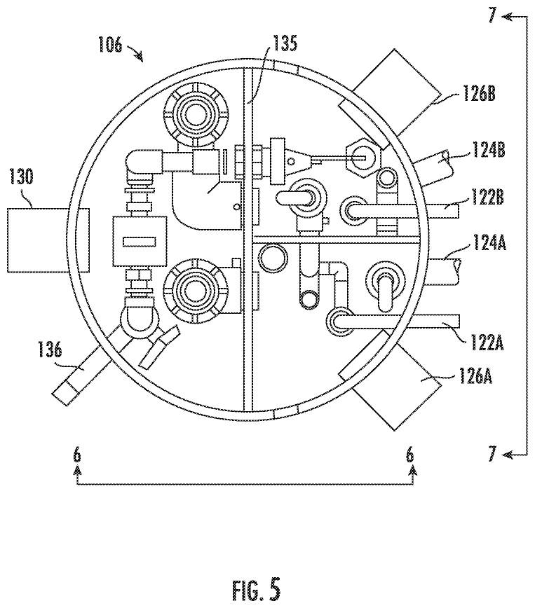

Referring now to FIG. 5, a top view of the basin 106 is depicted. As those of ordinary skill in the art can appreciate, the configuration of the basin, piping, pumps, etc. that is shown is exemplary rather than limiting. The basin 106 includes pumping equipment 132 for distributing water and also for circulating water through the networks of geothermal piping 104A, 104B. The pumping equipment 132 may be any known suitable pumping equipment such as centrifugal pumps, air lift pumps, and vacuum pumps, for example.

The basin 106 includes a divider 135 that separates the pumping equipment from first and second chambers 125A, 125B. An overflow drain 130 and a water supply pipe 136 are coupled adjacent to the pumping equipment 132. Chamber 125A is in fluid communication with sub-area 102A and chamber 125B of the basin 106 is in fluid communication with sub-area 102B. Chambers 125A, 125B are separated by wall 140 so that water can be pumped back and forth between the sub-areas 102A, 102B. In addition, the water can be pumped out through the geothermal piping 104A, 104B as needed to adjust a temperature of the water being distributed to the sub-areas 102A, 102B.

The pumping equipment 132 may be coupled to valves 134, which may be arranged in the conduits or couplings. The valves can be periodically opened and closed. Additionally or alternatively the valves can be kept at either opened or closed states for predetermined periods of time or an extended periods of time to completely drain the sub-areas 102A, 102B or soak/flood either or both the sub-areas for a certain period of time. The valves could be controlled manually by a user or be fully or partially controlled automatically by a controller or a computer system. The number and types of valves included in the system depends on the intended use and may vary accordingly.

The pumping equipment 132 may be configured to raise and lower a height level of the water at a root zone of the plants within the respective sub-area. For example, the pumping equipment 132 may be configured to alternatively raise and lower a height level of the water of the root zone of the respective sub-area by pumping the water to and from the first and second sub-areas 102A, 102B. Thus, by periodically raising and lowering the water level in the root zone of the sub-areas a gas exchange zone can be created in the root zone leading to optimal irrigation and oxygenation of the root zone.

Sensors may be placed in the conduits or the basin so that the temperature of the root zone can be efficiently adjusted without exposing the roots to direct contact with hot/cold water pipes which may be damaging to the plant roots.

Many modifications and other embodiments will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

That which is claimed is:

1. A geothermal aerification system comprising:
a basin having a first portion and a second portion;
a first network of geothermal piping in fluid communication with the first portion of the basin and a second network of geothermal piping in fluid communication with the second portion of the basin, the first and second networks of geothermal piping configured to adjust a temperature of water and are located at a depth below a ground surface to circulate the water to selectively absorb geothermal energy to increase a temperature of the water, or to dissipate heat to decrease the temperature of the water;
a first network of water distribution pipes in fluid communication with the first portion of the basin; and
a second network of water distribution pipes in fluid communication with the second portion of the basin;
wherein the first and second networks of water distribution pipes are configured to discharge the water at the adjusted temperature.

2. The geothermal aerification system of claim 1, further comprising pumping equipment to circulate the water through the first and second networks of geothermal piping and the first and second networks of water distribution pipes.

3. The geothermal aerification system of claim 2, wherein the pumping equipment comprises at least one of an air lift pump, a centrifugal pump, or a vacuum pump, and the pumping equipment is configured to raise and lower a height level of the water proximate to the ground surface.

4. The geothermal aerification system according to claim 3, further comprising one or more controllable valves configured to control a flow of the water.

5. The geothermal aerification system according to claim 4, wherein the basin is configured to store the water therein.

6. The geothermal aerification system according to claim 5, further comprising a substantially water impermeable layer positioned above the first and second networks of geothermal piping.

7. The geothermal aerification system according to claim 6, further comprising a substantially water permeable layer placed on top of the water impermeable layer.

8. The geothermal aerification system according to claim 7, further comprising a porous concrete layer positioned on top of the water permeable layer.

9. The geothermal aerification system according to claim 8, further comprising a rooting medium on top of the porous concrete layer.

10. The geothermal aerification system according to claim 8, further comprising a substantially sand layer on top of the porous concrete layer.

11. The geothermal aerification system according to claim 8, further comprising an inorganic layer on top of the porous concrete layer.

12. A geothermal aerification system comprising:
a basin for storing water;
a network of geothermal piping in fluid communication with the basin, the network of geothermal piping configured to adjust a temperature of the water and is located at a depth below a ground surface to circulate the water to selectively absorb geothermal energy to increase a temperature of the water, or to dissipate heat to decrease the temperature of the water; and
a network of water distribution pipes in fluid communication with the basin;
wherein the network of water distribution pipes is configured to discharge the water at the adjusted temperature and proximate to the ground surface.

13. The geothermal aerification system of claim 12, further comprising pumping equipment to circulate the water through the network of geothermal piping and the network of water distribution pipes.

14. The geothermal aerification system according to claim 13, wherein the basin is configured to store the water therein.

15. The geothermal aerification system according to claim 14, further comprising:
a substantially water impermeable layer positioned above the first and second networks of geothermal piping;
a substantially water permeable layer placed on top of the water impermeable layer; and
a porous concrete layer positioned on top of the water permeable layer.

16. The geothermal aerification system according to claim 15, further comprising a rooting medium on top of the porous concrete layer.

17. A method of using a geothermal aerification system comprising a basin for storing water, a network of geothermal piping at a depth below a ground surface to selectively absorb or dissipate geothermal energy, and a network of water distribution pipes in fluid communication with the basin, the method comprising:
circulating water from the basin to the network of geothermal piping to adjust a temperature of the water; and
discharging the water through the network of water distribution pipes at the adjusted temperature and proximate to the ground surface.

18. The method of claim 17, wherein the geothermal aerification system further comprises
a substantially water impermeable layer positioned above the first and second networks of geothermal piping,
a substantially water permeable layer placed on top of the water impermeable layer, and
a porous concrete layer positioned on top of the water permeable layer.

19. The method of claim 18, wherein the geothermal aerification system further comprises pumping equipment to circulate the water through the network of geothermal piping and the network of water distribution pipes.

20. The method of claim 19, wherein the geothermal aerification system further comprises a rooting medium on top of the porous concrete layer or an inorganic layer.
